(19) United States
(12) Patent Application Publication
(10) Pub. No.: US 2011/0239537 A1
(43) Pub. Date: Oct. 6, 2011

(54) Hydroponics Multi Box and Glass House Having Hydroponics Multi Box

(76) Inventors: Hyung Sik Lee, Seoul (KR); Hae Soo Chung, Toronto (CA)

(21) Appl. No.: 12/754,793

(22) Filed: Apr. 6, 2010

(51) Int. Cl. A01G 31/00; A01G 9/02; A01G 9/14

(52) U.S. Cl. 47/60

(57) ABSTRACT

The present invention relates to a hydroponics multi box and a glass house having the same, wherein the hydroponics multi box includes a bottom surface in the rectangular shape formed of first to fourth sides, inclined at a predetermined angle from the first side towards the second side, and formed with a drain hole adjacent to the second side, first to fourth side surfaces folded and extended upward from the respective sides of the bottom surface, and an opened top surface part inclined at a predetermined angle corresponding to the inclination of the bottom surface, wherein the first and second side surfaces respectively extended from their facing first and second sides are formed with first and second inward stepped portions. According to the present invention, bed soil may receive maximum sunlight, be kept with uniform amounts of moisture and nutrient solutions therein, and be restrained in the increase of temperature over a predetermined temperature, the hydroponics multi box may be moved or mounted easily, and the glass house having the same may carry out the ventilation of atmospheric air and natural lighting simply.

### BACKGROUND OF THE INVENTION

(a) Technical Field

The present invention relates to a technique for effectively realizing hydroponics of crops, and more particularly to, a hydroponics multi box in which bed soil may receive maximum sunlight, be kept with uniform amounts of moisture and nutrient solutions therein, and be restrained in the increase of temperature over a predetermined temperature, and which may be moved or mounted easily, and a glass house having such hydroponics multi boxes, which is easy to carry out ventilation of atmospheric air and natural lighting.

(b) Description of the Related Art

The hydroponics of crops are, as well known in the art, divided into fresh water type hydroponics, bed soil type hydroponics and water spraying type hydroponics.

In the prior art hydroponics of crops, hydroponics beds are assembled in the horizontal structure and finished by waterproof clothes, for example, made of tarpaulin materials at the upper parts of the assembled hydroponics beds. In the case of the bed soil type hydroponics, after watering, nutrient solutions are soaked into the hydroponics beds and accumulated at the lower parts of the hydroponics beds. In this case, the accumulated nutrient solutions at the lower parts of the hydroponics beds are not drained to the outside and ventilation is not carried out, so that the growth of crops is not amicable due to the excessive humidity in the hydroponics beds and the accumulated amounts of the nutrient solutions.

Further, if the hydroponics beds assembled in the horizontal structure are integrated with the waterproof clothes, the spread of disease in the crops and the diffusion of pollution due to rotten crops become faster and easier. Therefore, the bed soil stacked in the hydroponics beds should be exchanged with new one in a short time. In this case, there are disadvantages that the integrated hydroponics beds and the waterproof clothes should be entirely disassembled for the exchange of the bed soil and that the new hydroponics beds and the new waterproof clothes should be complicatedly assembled with each other again after the disassembling.

### SUMMARY OF THE INVENTION

The present invention has been accomplished in order to resolve the above-mentioned disadvantages and any other problems, and an object of the present invention is to provide a hydroponics multi box, in which bed soil may receive maximum sunlight, be kept with uniform amounts of moisture and nutrient solutions therein, and be restrained in the increase of temperature over a predetermined temperature, and which may be moved or mounted easily.

Further, another object of the present invention is to provide a glass house having such hydroponics multi boxes, in which bed soil may receive maximum sunlight, be kept with uniform amounts of moisture and nutrient solutions therein, and be restrained in the increase of temperature over a predetermined temperature, and which may be moved or mounted easily, wherein ventilation between the hydroponics multi boxes and atmospheric air and natural lighting from the sun may be carried out simply.

In order to accomplish the above objects, according to a first aspect of the present invention, there is provided a hydroponics multi box in the hexahedron shape with an opened top surface part, including a bottom surface in the rectangular shape formed of first to fourth sides, inclined at a predetermined angle from the first side towards the second side, and having a drain hole adjacent to the second side, and first to fourth side surfaces folded and extended upward from the respective sides of the bottom surface, wherein the opened top surface part is inclined at a predetermined angle corresponding to the inclination of the bottom surface, and the first and second side surfaces respectively extended from their facing first and second sides are formed with first and second inward stepped portions.

In the hydroponics multi box according to the first aspect of the present invention, a non-woven fabric may be attached to an upper part of the drain hole of the bottom surface.

In the hydroponics multi box according to the first aspect of the present invention, the first side surface may be opened partially.

In the hydroponics multi box according to the first aspect of the present invention, the first side surface has a through-hole formed at a side of the first side surface and provided with an opening and closing element, so that the through-hole may be opened at or above a predetermined temperature or a predetermined humidity.

In the hydroponics multi box according to the first aspect of the present invention, the opening and closing element may be made of shape memory alloy.

According to a second aspect of the present invention, there is provided a glass house having hydroponics multi boxes, including the hydroponics multi boxes each having a bottom surface in the rectangular shape formed of first to fourth sides, inclined at a predetermined angle from the first side towards the second side, and formed with a drain hole adjacent to the second side, first to fourth side surfaces folded and extended upward from the respective sides of the bottom surface, and an opened top surface part inclined at a predetermined angle corresponding to the inclination of the bottom surface, wherein the first and second side surfaces extended from respectively facing first and second sides are formed with first and second inward stepped portions; receiving frames having receiving spaces disposed vertically for receiving the plurality of the hydroponics multi boxes so that the hydroponics multi boxes are stacked; and a glass house frame having an inner space disposed with a plurality of the receiving frames horizontally.

In the glass house having hydroponics multi boxes according to the second aspect of the present invention, each of the receiving frames has rollers mounted at both sides of the respective receiving spaces for receiving the hydroponics multi boxes in such a manner that the first and second stopped portions of the hydroponics multi boxes may slide to move at the upper parts of the respective rollers.

In the glass house having hydroponics multi boxes according to the second aspect of the present invention, a ventilation window is formed at a lower side of the glass house frame, which is adjacent to the ground surface.

In the glass house having hydroponics multi boxes according to the second aspect of the present invention, a non-woven fabric is attached to the upper part of the drain hole of the bottom surface.

In the glass house having hydroponics multi boxes according to the second aspect of the present invention, the first side surface is opened partially.

In the glass house having hydroponics multi boxes according to the second aspect of the present invention, the first side surface has a through-hole formed at a side of the first side surface and provided with an opening and closing element, so that the through-hole is opened at or above a predetermined temperature or a predetermined humidity.

In the glass house having hydroponics multi boxes according to the second aspect of the present invention, the opening and closing element is made of shape memory alloy materials.

In the hydroponics multi box and the glass house having the same according to the present invention, the hydroponics multi box is formed in a hexahedron shape inclined at a predetermined angle so that bed soil or crops planted in the bed soil may receive a maximum amount of sunlight, a bottom surface is formed with a drain hole so that the amounts of moisture and nutrient solutions may be kept uniformly in the bed soil, a side surface is partially opened or closed so as to restrain the increase of temperature of the bed soil at a predetermined temperature or higher, and side surfaces facing each other are formed with stepped portions so that the hydroponics multi box may be moved or mounted easily by the sliding of the rollers through the stepped portions.

Further, in the glass house having such hydroponics multi boxes according to the present invention, ventilation between the hydroponics multi boxes and external environments may be carried out smoothly and natural lighting from the sun becomes easy, so that the crops planted in the hydroponics multi boxes may grow more vigorously.

### BRIEF DESCRIPTION OF THE DRAWINGS

The objects, features and advantages of the present invention will be more clearly understood from the preferred embodiments in the following detailed description in conjunction with the accompanying drawings, in which:

FIG. 1a is a schematic perspective view showing a hydroponics multi box according to a preferred embodiment of the present invention;

FIG. 1b is a schematic cross-sectional view showing the hydroponics multi box of FIG. 1a;

FIG. 1c is a schematic plane view showing the hydroponics multi box of FIG. 1a;

FIG. 2 is a schematic view showing the structure of a glass house having hydroponics multi boxes according to another preferred embodiment of the present invention; and

FIG. 3 is an expanded cross-sectional view showing a receiving frame of the glass house having hydroponics multi boxes of FIG. 2.

### DETAILED DESCRIPTION OF THE EMBODIMENT

In the following detailed description, only certain exemplary embodiments of the present invention have been shown and described, simply by way of illustration.

As those skilled in the art would realize, the described embodiments may be modified in various different ways, all without departing from the spirit or scope of the present invention.

Now, preferred embodiments of the present invention in order to achieve the objects of the present invention will be described in more detail with reference to the accompanying drawings.

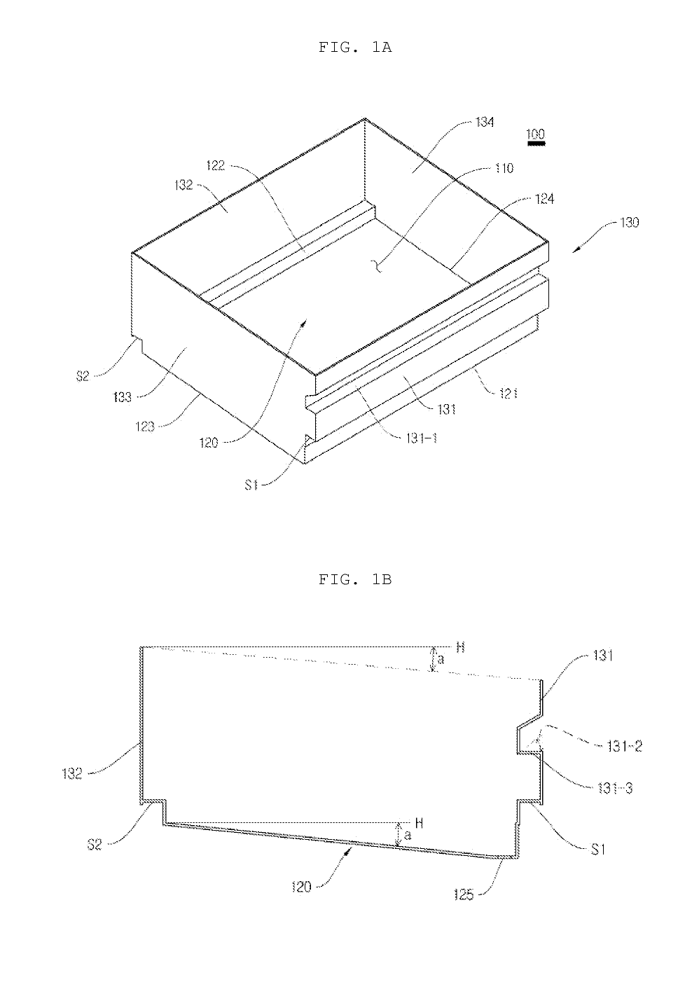

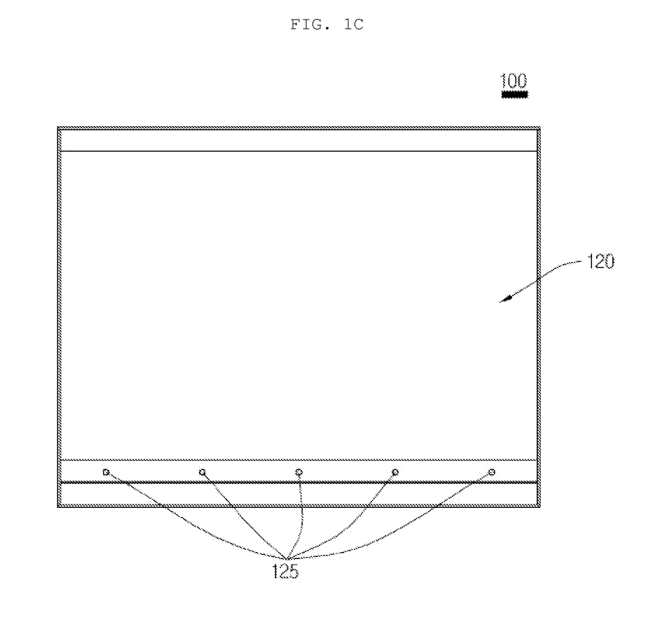

FIG. 1a is a schematic perspective view showing a hydroponics multi box according to a preferred embodiment of the present invention, FIG. 1b is a schematic cross-sectional view showing the hydroponics multi box of FIG. 1a, and FIG. 1c is a schematic plane view showing the hydroponics multi box of FIG. 1a.

Referring to FIG. 1a to FIG. 1c, a hydroponics multi box 100 according to a preferred embodiment of the present invention is in the hexahedron shape with an opened surface part and, for example, includes an opened top surface part 110, an inclined bottom surface 120 and side surfaces 130 extended from the bottom surface 120.

The bottom surface 120 of the hydroponics multi box 100 is formed of a flat plate in the substantially rectangular shape with first to fourth sides 121-124 and, as shown in FIG. 1b, inclined at a predetermined angle, for example, 6° downwards from a horizontal surface H, which is parallel to the ground surface in the direction from the first side 121 towards the second side 122, wherein a drain hole 125 is penetratingly formed in the proximity of the second side 122. The drain hole 125 drains nutrient solutions to the outside after watering so as to prevent the nutrient solutions from being accumulated on the bottom surface 120, thereby continuously keeping a predetermined amount of moisture and a predetermined amount of the nutrient solutions, both being proper for the growth of the crops, in the bed soil. Further, the bottom surface 120 is inclined at a predetermined angle “a”, for example, 6°, from the horizontal surface H, which is parallel to the ground surface in the direction from the first side 121 towards the second side 122, so that the moisture and the nutrient solutions soaked into the bed soil may be naturally introduced into the drain hole 125 by gravity, thereby being drained to the outside.

The nutrient solutions represent aqueous solutions, into which nutrients essential for the growth and development of crops are dissolved, and the bed soil represents soil for seedbeds, which may supply sufficient nutrients to rice plants and requires sufficient water-permeability, air-permeability and water-retentive property.

In the meantime, a non-woven fabric (not shown) may be attached at an upper part of the drain hole 125 of the bottom surface 120. That is, the non-woven fabric helps the smooth drain of the moisture and the nutrient solutions towards the drain hole 125 while preventing the unnecessary leakage of the bed soil to the outside.

The side surface 130 is formed of first to fourth side surfaces 131-134, which are folded and extended upward from the respective sides 121-124 of the bottom surface 120. In the side surface 130, as shown in FIG. 1a, the first side surface 131 and the second side surface 132 face each other and the third side surface 133 and the fourth side surface 134 face each other.

Specifically, a first stepped portion S1 is formed inwards at a lower part of the first side surface 131, which is folded vertically upwards from the first side 121 of the bottom surface 120, and a second stepped portion S2 is formed inwards at a lower part of the second side surface 132, which is folded vertically upwards from the second side 122 of the bottom surface 120.

The first and second stepped portions S1 and S2 may be indentedly formed at upper parts of rollers 220 of a receiving frame 200, which will be described later with reference to FIG. 3, for the sliding movement of the hydroponics multi box 100. That is, the hydroponics multi box 100 may be easily moved and mounted with respect to a receiving space 210 of the receiving frame 200 by the first and second stepped portions S1 and S2, which slide on the rollers 220 of the receiving frame 200, so that the hydroponics multi box 100 may be removed from the receiving space 210 of the receiving frame 200 or substituted with a new one.

In the meantime, as mentioned below, it is possible to prevent the increase of temperature or humidity of the bed soil beyond a predetermined temperature or a predetermined humidity, which is proper for the growth of crops, by two structural characteristics of the first side surface 131.

First, a part 131-1 of the first side surface 131 may be opened. That is, smooth ventilation between the bed soil and the outside may be realized by the opened structure of the part 131-1, so that it is possible to prevent the unnecessary increase of the temperature or humidity of the bed soil beyond a predetermined temperature or a predetermined humidity, which is proper for the growth of crops.

Second, a through-hole 131-3 may be formed in the first side surface 131 by opening or closing the part 131-1 with an opening and closing element 131-2. That is, if the temperature or humidity of the bed soil is increased beyond the predetermined temperature or humidity, which is proper for the growth of crops, the opening and closing element 131-2 opens the through-hole 131-3 so as to keep the bed soil at the predetermined temperature or humidity, which is proper for the growth of the crops. At this time, the opening and closing element 131-2 may be formed of shape memory alloy materials to be deformed for opening the through-hole 131-3 if the temperature or humidity of the bed soil is higher than the predetermined temperature or humidity, while restored to its original state for closing the through-hole 131-3 if the temperature or humidity of the bed soil is below the predetermined temperature or humidity.

In the meantime, the opened top surface part 110 is formed to be inclined downwards at a predetermined angle “a” from the horizontal surface H, which is parallel to the ground surface, corresponding to the inclination of the bottom surface 120. That is, since the top surface 110 is inclined at a predetermined angle “a”, for example, 6° to receive maximum sunlight, for example, the maximum morning sunlight, photosynthetic light reaction may be realized vigorously with the sufficiently received sunlight, promoting the growth of the crops.

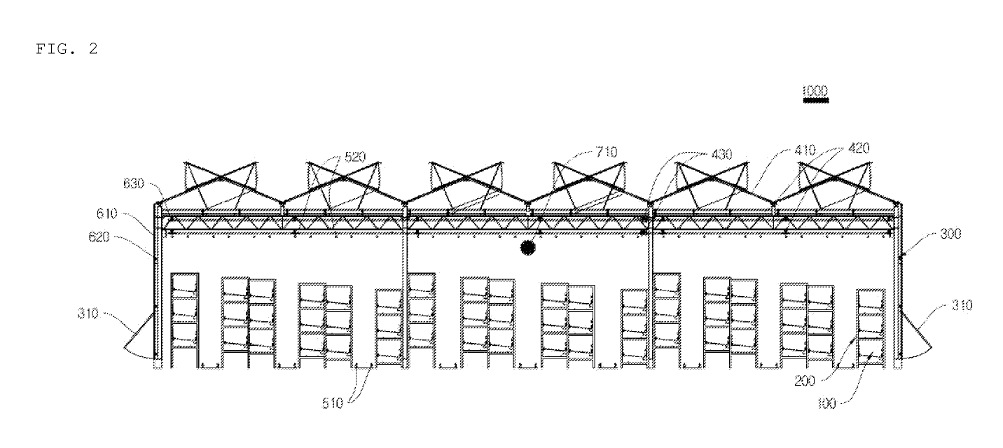

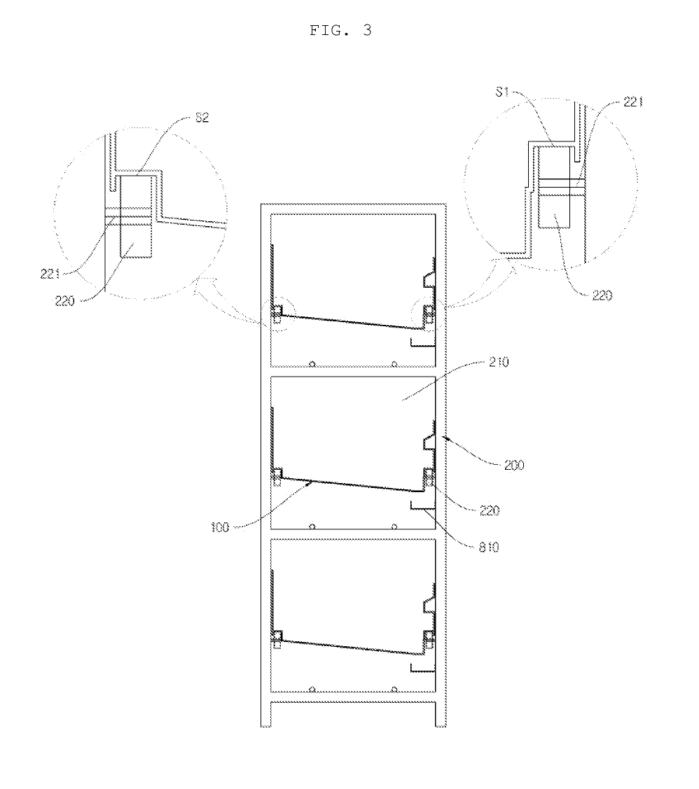

FIG. 2 is a schematic view showing the structure of a glass house having hydroponics multi boxes according to another preferred embodiment of the present invention, and FIG. 3 is an expanded cross-sectional view showing a receiving frame of the glass house having hydroponics multi boxes of FIG. 2

Referring to FIG. 2 and FIG. 3, a glass house 1000 having hydroponics multi boxes according to another preferred embodiment of the present invention includes hydroponics multi boxes 100, receiving frames 200 for receiving the hydroponics multi boxes 100 and a glass house frame 300, wherein the hydroponics multi box 100 in the glass house 1000 having hydroponics multi boxes according to this embodiment of the present invention has the same shape and structure with those of the hydroponics multi box 100 as explained above with reference to FIG. 1a to FIG. 1c, so that the detailed explanation thereof will be omitted to avoid redundancy.

The receiving frame 200 has a plurality of receiving spaces 210, which are independently divided from each other and disposed vertically for respectively receiving the hydroponics multi box 100. Each of the receiving space 210 of the receiving frame 200 is provided with rotational rollers 220 at both sides in such a manner that the first and second stepped portions S1 and S2 of the hydroponics multi box 100 may slide on the rollers 220 for the smooth movement of the hydroponics multi box 100 to be received in the receiving space 210. Further, the first and second stepped portions S1 and S2 of the hydroponics multi box 100 may slide on the rollers 220 in order to remove the hydroponics multi box 100 from the receiving space 210 and exchange the same with a new one as necessary. Even though, in this embodiment, each of the receiving frames 200 has three receiving spaces 210 separated from one another and disposed vertically, it is also possible to form the receiving frame 200 with receiving spaces 210 of various shapes and structures according to the growth conditions of crops or the structure of spaces defined by the glass house frame 300. The rollers 220 may be rotatably coupled with shafts 221 extended from the receiving frame 220.

The glass house frame 300 forms the appearance of the glass house 1000 having hydroponics multi boxes and provides a plurality of inner spaces, in which a plurality of receiving frames 200 are disposed horizontally. A plurality of ventilation windows 310 may be formed at the lower part of the glass house frame 300, which is adjacent to the ground surface. The ventilation windows 310 serve as vents towards the outside of the glass house frame 300 so as to uniformly keep the temperature and the humidity proper for the growth of crops, thereby promoting the growth of the crops.

Reference symbol 410 indicates a tempered glass for natural lighting, reference symbol 420 indicates a light-shield/warmth-keeping screen, and reference symbol 430 indicates an opening and closing element for the screen. Reference symbols 510 and 520 respectively indicate upper and lower heating parts for realizing proper temperature for the growth of crops. Reference symbol 610 indicates each side screen formed at each side surface of the glass house frame 300, reference symbol 620 indicates an opening and closing element for the side screen, and reference symbol 630 indicates a screen box for keeping the side screen. Reference symbol 710 indicates a circulation fan for circulating air of the inner space of the glass house frame 300. Reference symbol 810 indicates a drain path for the moisture and the nutrient solutions, which are drained via the drain hole 125 of the hydroponics multi box 100 to the outside.

The above-mentioned terms are set in consideration of functions in the present invention, which may be changed according to the intention of manufacturers or practice in the fields, and should be defined on the basis of the entire contents in the specification.

Further, even though the hydroponics multi box and the glass house having the same have been described in detail with reference to the forgoing embodiments and accompanying drawings, the present invention is not limited thereto and it is apparent to those skilled in the art that various changes and modifications of the present invention may be made without departing the spirit and scope of the invention. It is intended that such changes be included within the spirit and scope of the claims appended hereto.

What is claimed is:

1. A hydroponics multi box in the hexahedron shape with an opened top surface part, comprising:
a bottom surface in the rectangular shape formed of first to fourth sides, inclined at a predetermined angle from the first side towards the second side, and having a drain hole adjacent to the second side; and
first to fourth side surfaces folded and extended upward from the respective sides of the bottom surface;
wherein the opened top surface part is inclined at a predetermined angle corresponding to the inclination of the bottom surface, and the first and second side surfaces respectively extended from their facing first and second sides are formed with first and second inward stepped portions.

2. The hydroponics multi box as claimed in claim 1, wherein a non-woven fabric is attached to an upper part of the drain hole of the bottom surface.

3. The hydroponics multi box as claimed in claim 1, wherein the first side surface is opened partially.

4. The hydroponics multi box as claimed in claim 1, wherein the first side surface has a through-hole formed at a side of the first side surface and provided with an opening and closing element, so that the through-hole is opened at or above a predetermined temperature or a predetermined humidity.

5. The hydroponics multi box as claimed in claim 4, wherein the opening and closing element is made of shape memory alloy.

6. A glass House having hydroponics multi boxes, comprising:
the hydroponics multi boxes, each having a bottom surface in the rectangular shape formed of first to fourth sides, inclined at a predetermined angle from the first side towards the second side, and formed with a drain hole adjacent to the second side, first to fourth side surfaces folded and extended upward from the respective sides of the bottom surface, and an opened top surface part inclined at a predetermined angle corresponding to the inclination of the bottom surface, wherein the first and second side surfaces extended from respectively facing first and second sides are formed with first and second inward stepped portions;
receiving frames having receiving spaces disposed vertically for receiving a plurality of the hydroponics multi boxes so that the hydroponics multi boxes are stacked; and
a glass house frame having an inner space disposed with a plurality of the receiving frames horizontally.

7. The glass House as claimed in claim 6, wherein each of the receiving frames has rollers mounted at both sides of the respective receiving spaces for receiving the hydroponics multi boxes in such a manner that the first and second stopped portions of the hydroponics multi boxes slide to move at upper parts of the respective rollers.

8. The glass House as claimed in claim 6, wherein a ventilation window is formed at a lower side of the glass house frame, which is adjacent to the ground surface.

9. The glass House as claimed in claim 6, wherein a non-woven fabric is attached to an upper part of the drain hole of the bottom surface.

10. The glass House as claimed in claim 6, wherein the first side surface is opened partially.

11. The glass House as claimed in claim 6, wherein the first side surface has a through-hole formed at a side of the first side surface and provided with an opening and closing element, so that the through-hole is opened at or above a predetermined temperature or a predetermined humidity.

12. The glass House as claimed in claim 11, wherein the opening and closing element is made of shape memory alloy.
